(19) United States
(12) Patent Application Publication
(10) Pub. No.: US 2013/0076086 A1
(43) Pub. Date: Mar. 28, 2013

(54) REAR IMPACT HEAD DISPLACEMENT REDUCTION THROUGH THE APPLICATION OF STRAIN RATE HARDENING CUSHIONING MATERIALS

(71) Applicants: Douglas M. Pickett, Sterling Heights, MI (US); Carol C. Hathaway, Rochester, MI (US)

(72) Inventors: Douglas M. Pickett, Sterling Heights, MI (US); Carol C. Hathaway, Rochester, MI (US)

(73) Assignee: GM GLOBAL TECHNOLOGY OPERATIONS LLC, Detroit, MI (US)

(21) Appl. No.: 13/247,193

(22) Filed: Sep. 28, 2011

(51) Int. Cl. B60N 2/42; B60N 2/48

(52) U.S. Cl. 297/216.12; 297/391

(57) ABSTRACT

A head restraint for a seat includes a core support structure supporting a dual rate cushioning foam. The dual rate cushioning foam includes a dilatant material that changes from a first compression rate providing a first stiffness to a second compression rate providing a second stiffness in response to a strain rate in the dilatant material rising above a pre-defined limit. The first compression rate at the first stiffness provides a softer feel to the occupant for normal operation of the vehicle. The second compression rate at the second stiffness provides a stiffer resistance to resist the sudden rearward movement of the occupant's head in the event of a sudden rear impact.

### TECHNICAL FIELD

The invention generally relates to a head restraint for a seat of a vehicle, and a method of resisting rearward movement of a head of an occupant with the head restraint in response to a sudden rear impact of the vehicle.

### BACKGROUND

Vehicular seats include a head restraint to resist rearward movement of an occupant's head in the event of a sudden rear impact of the vehicle. The head restraint includes a core support structure that is rigidly attached to the seat, and a layer of foam disposed over the core support structure to cushion the core support structure. Typically, the head restraint is positioned closely behind the occupant's head in order to limit the rearward movement of the occupant's head in the event of an impact. The head restraint is positioned closely behind the occupant's head to compensate for the compression of the foam during the act of restraining the occupant's head. This position of the head restraint may bring the cushioning foam into contact with the occupant during normal operation of the vehicle, which occupants may find objectionable.

### SUMMARY

A head restraint for a seat of a vehicle is provided. The head restraint includes a core support structure that is configured for attachment to the seat, and a dual rate cushioning foam. The dual rate cushioning foam is attached to and supported by the core support structure. The dual rate cushioning foam is changeable between a first compression rate providing a first pre-determined stiffness, and a second compression rate providing a second pre-determined stiffness.

A seat for a vehicle is also provided. The seat includes a backrest, and a head restraint supported by the backrest. The head restraint extends vertically upward from the backrest. The head restraint includes a core support structure, and a dual rate cushioning foam attached to and supported by the core support structure. The dual rate cushioning foam is changeable between a first compression rate and a second compression rate. When at the first compression rate, the dual rate cushioning foam provides a first pre-determined stiffness. When at the second compression rate, the dual rate cushioning foam provides a second pre-determined stiffness. The second compression rate and the second stiffness are greater than the first compression rate and the first stiffness respectively. The dual rate cushioning foam includes a dilatant material responsive to a change in a strain rate of the dilatant material to change between the first compression rate and the second compression rate.

A method of resisting rearward movement of a head of a vehicular occupant in response to a rear impact event is also provided. The method includes supporting the head of the occupant with a head restraint disposed rearward of the occupant. A strain rate in a dual rate cushioning foam of the head restraint is sensed in response to the head of the occupant moving rearward relative to the head restraint. When the strain rate of the dual rate cushioning foam is greater than a pre-defined limit, a compression rate of the dual rate cushioning foam is changed from a first compression rate providing a first stiffness to a second compression rate providing a second stiffness. The second stiffness is greater than the first stiffness.

Accordingly, the dual rate cushioning foam provides the first compression rate having a lower stiffness until the strain rate in the dilatant material increases above a pre-defined limit, at which time the dual rate cushioning foam changes from the first compression rate to the second compression rate to provide a higher stiffness. As such, the head restraint may be positioned more rearward of the occupant's head to improve occupant comfort, while still providing proper restriction to rearward movement of the occupant's head during a rear impact event.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic partially cross sectional side view of a seat for a vehicle.

FIG. 2 is a schematic front perspective view of a forward side of the seat.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

Referring to the Figures, wherein like numerals indicate like parts throughout the several views, a seat is generally shown at 20. The seat 20 is for a vehicle, and includes a backrest 22 and a head restraint 24. The seat 20 may include any type and/or style of seat 20, such as but not limited to a bucket seat 20 or a bench seat 20. Furthermore, the seat 20 may be positioned at any location within the vehicle such as but not limited to a front seat 20 or a back seat 20.

The head restraint 24 is attached to and supported by the backrest 22. The head restraint 24 extends vertically upward from the backrest 22. The head restraint 24 may be attached to the backrest 22 in any suitable manner, and may be moveably attached to the backrest 22 to allow for vertical adjustment and/or pivotal adjustment relative to the backrest 22.

The head restraint 24 includes a core support structure 26. The core support structure 26 is configured for attachment to the backrest 22 of the seat 20. The core support structure 26 may include any suitable rigid structure, and may be manufactured from but is not limited to a plastic or metal material. The support structure 26 may include any desirable size and/or configuration, and may include any necessary brackets, adjustments, connections, position locks, etc.

A dual rate cushioning foam 28 is attached to and supported by the core support structure 26. The dual rate cushioning foam 28 is positioned on a forward side 30 of the core support structure 26 for engaging a rearward moving head 32 of an occupant, indicated by direction arrow 34. As such, in the event the vehicle is struck from the rear, the occupant's head 32 moves rearward into engagement with the head restraint 24, with the head restraint 24 positioned to limit the rearward movement of the occupant's head 32.

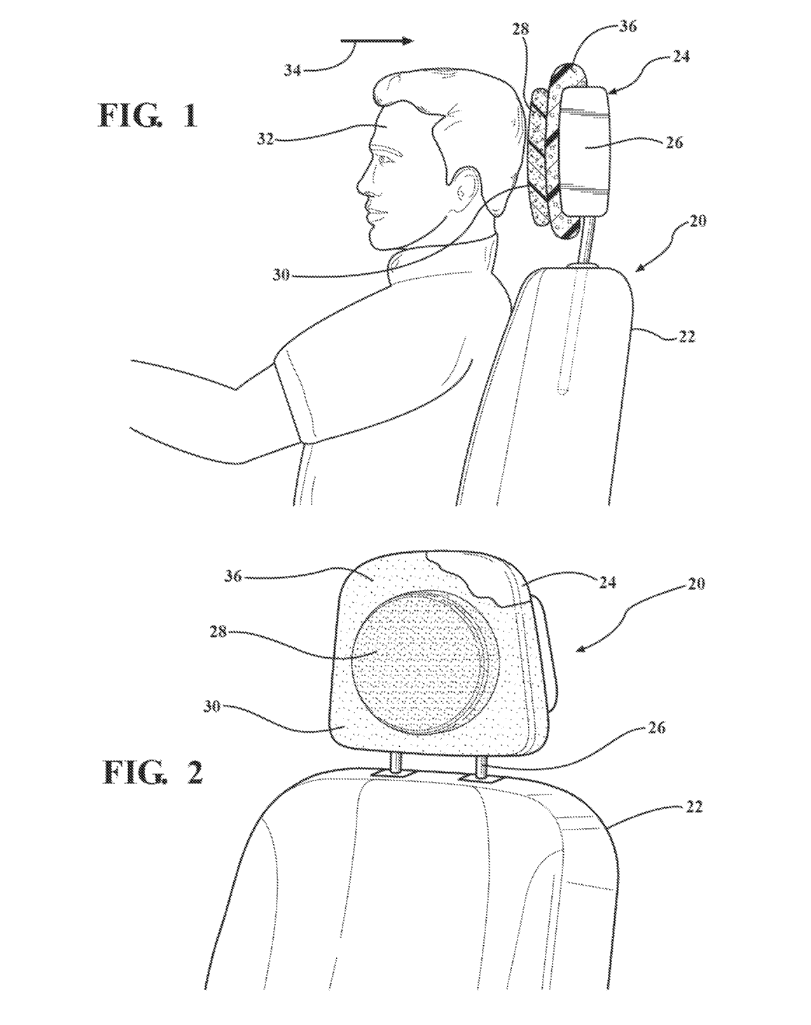

The head restraint 24 may further include a single rate cushioning foam 36. The single rate cushioning foam 36 is also attached to and supported by the core support structure 26. The single rate cushioning foam 36 may encircle the dual rate cushioning foam 28, and may further extend about the periphery of the core support structure 26, as is shown in FIG. 2. Alternatively, as is shown in FIG. 1, the single rate cushioning foam 36 may be disposed only on the forward side 30 of the head restraint 24, and need not extend about the entire periphery of the core support structure 26. Furthermore, as is shown in FIG. 1, the dual rate cushioning foam 28 may be positioned adjacent, i.e., immediately next to, the single rate cushioning foam 36 on the forward side of the head restraint 24, and need not be encircled by the single rate cushioning foam 36 as is shown in FIG. 2. The dual rate cushioning foam 28 may further include any suitable and/or desirable shape required to meet the design and/or aesthetic requirements of the vehicle. For example, the dual rate cushioning foam 28 may include a rectangular shape, a circular shape, an oval shape, or any other suitable shape.

The single rate cushioning foam 36 includes a single compression rate. The single compression rate provides a single pre-determined stiffness. As used herein, the term stiffness may be defined as a resistance to compression, and the term compression rate may be defined as the speed at which an object is compressed. The single rate cushioning foam 36 may include any standard foam material, such as but not limited to a polyurethane material or some other elastomeric foamed material. While the head restraint 24 is shown and described herein as including both the dual rate cushioning foam 28 and the single rate cushioning foam 36, it should be appreciated that the head restraint 24 may include only the dual rate cushioning foam 28.

The dual rate cushioning foam 28 is changeable between a first compression rate and a second compression rate. The first compression rate provides a first pre-determined stiffness, and the second compression rate provides a second pre-determined stiffness. The second compression rate and the second stiffness are greater than the first compression rate and the first stiffness respectively. The softer and more compressible first compression rate and/or first stiffness provide a comfortable support for the occupant's head 32 during normal operation of the vehicle. The harder and less compressible second compression rate and/or second stiffness provide increased support or resistance to movement to further limit the rearward movement of the occupant's head 32 during a rear impact event. Accordingly, the dual rate cushioning foam 28 is changeable between the first compression rate and the second compression rate to provide optimum comfort at the first compression rate during normal operation of the vehicle, to provide optimum support at the second compression rate during a rear impact event to limit the rearward movement of the occupant's head 32.

The dual rate cushioning foam 28 may include a dilatant material, defined herein as a material that increases in viscosity or resistance to compression as a result of deformation by expansion, pressure or agitation. The dilatant material is responsive to an actuation signal to change between the first compression rate and the second compression rate. The actuation signal of the dilatant material may include but is not limited to a strain rate of the dilatant material. The strain rate of the dilatant material includes a change in strain of the dilatant material over a period of time. Accordingly, if the strain rate of the dilatant material rises above a pre-defined limit, i.e., when the strain of the dilatant material changes more than a given amount over a pre-defined period of time, then the dilatant material of the dual rate cushioning foam 28 automatically changes from the first compression rate to the second compression rate. For example, in response to a rear impact event, the occupant's head 32 moves rearward into engagement with the dual rate cushioning foam 28 of the head restraint 24. The rapid rearward movement quickly compresses the dilatant material of the dual rate cushioning foam 28, thereby causing strain in the dilatant material. If the change in the strain of the dilatant material occurs quickly enough, the strain rate of the dilatant material will rise above the pre-defined limit, and the dilatant material changes from the first compression rate to the second compression rate to resist the rearward movement of the occupant's head 32. When the occupant's head 32 stops moving rearward, thereby stopping the change in the strain of the dilatant material, the strain rate falls back below the pre-defined limit, and the dilatant material changes from the second compression rate to the first compression rate. It should be appreciated that the dilatant material and the actuation signal may vary from the specific exemplary materials and/or signal described above.

While the best modes for carrying out the invention have been described in detail, those familiar with the art to which this invention relates will recognize various alternative designs and embodiments for practicing the invention within the scope of the appended claims.

1. A head restraint for a seat of a vehicle, the head restraint comprising:
a core support structure configured for attachment to the seat; and
a dual rate cushioning foam attached to and supported by the core support structure;
wherein the dual rate cushioning foam is changeable between a first compression rate providing a first pre-determined stiffness and a second compression rate providing a second pre-determined stiffness.

2. A head restraint as set forth in claim 1 wherein the second compression rate is greater than the first compression rate.

3. A head restraint as set forth in claim 2 wherein the second stiffness is greater than the first stiffness.

4. A head restraint as set forth in claim 2 wherein the dual rate cushioning foam changes from the first compression rate to the second compression rate in response to a strain rate in the dual foam cushioning foam rising above a pre-defined limit.

5. A head restraint as set forth in claim 4 wherein the strain rate of the dual rate cushioning foam includes a change in strain of the dual rate cushioning foam over a period of time.

6. A head restraint as set forth in claim 1 wherein the dual rate cushioning foam includes a dilatant material responsive to an actuation signal to change between the first compression rate and the second compression rate.

7. A head restraint as set forth in claim 6 wherein the actuation signal of the dilatant material includes a strain rate of the dilatant material, wherein the strain rate of the dilatant material includes a change in strain of the dilatant material over a period of time.

8. A head restraint as set forth in claim 1 wherein the dual rate cushioning foam is positioned on a forward side of the core support structure and configured for engaging a rearward moving head of an occupant.

9. A head restraint as set forth in claim 8 further comprising a single rate cushioning foam attached to and supported by the core support structure.

10. A head restraint as set forth in claim 9 wherein the single rate cushioning foam encircles the dual rate cushioning foam.

11. A head restraint as set forth in claim 9 wherein the dual rate cushioning foam is disposed adjacent a forward surface of the single rate cushioning foam.

12. A head restraint as set forth in claim 9 wherein the single rate cushioning foam includes a single compression rate providing a single pre-determined stiffness.

13. A seat for a vehicle, the seat comprising:
a backrest; and
a head restraint supported by the backrest and extending vertically upward from the backrest, wherein the head restraint includes:
a core support structure; and
a dual rate cushioning foam attached to and supported by the core support structure;
wherein the dual rate cushioning foam is changeable between a first compression rate providing a first pre-determined stiffness and a second compression rate providing a second pre-determined stiffness;
wherein the second compression rate and the second stiffness are greater than the first compression rate and the first stiffness respectively; and
wherein the dual rate cushioning foam includes a dilatant material responsive to a change in a strain rate of the dilatant material to change between the first compression rate and the second compression rate.

14. A seat as set forth in claim 13 further comprising a single rate cushioning foam attached to and supported by the core support structure.

15. A seat as set forth in claim 14 wherein the single rate cushioning foam encircles the dual rate cushioning foam.

16. A seat as set forth in claim 15 wherein the single rate cushioning foam includes a single compression rate providing a single pre-determined stiffness.

17. A method of resisting rearward movement of a head of a vehicular occupant in response to a rear impact event, the method comprising:
supporting the head of the occupant with a head restraint disposed rearward of the occupant;
sensing a strain rate in a dual rate cushioning foam of the head restraint in response to the head of the occupant moving rearward relative to the head restraint;
changing a compression rate of the dual rate cushioning foam from a first compression rate providing a first stiffness to a second compression rate providing a second stiffness greater than the first stiffness when the strain rate of the dual rate cushioning foam is greater than a pre-defined limit.

18. A method as set forth in claim 17 wherein the dual rate cushioning foam includes a dilatant material responsive to a change in the strain rate therein to change between the first compression rate and the second compression rate.

19. A method as set forth in claim 17 wherein sensing a strain rate in the dual rate cushioning foam includes sensing a strain in the dual rate cushioning foam over a period of time.

20. A method as set forth in claim 17 further comprising changing the compression rate of the dual rate compression foam from the second compression rate to the first compression rate in response to the strain rate of the dual rate cushioning foam falling below the pre-defined limit.
